(19) United States
(12) Patent Application Publication
(10) Pub. No.: US 2005/0138396 A1
(43) Pub. Date: Jun. 23, 2005

(54) Method and system for protecting a hard disk

(75) Inventors: Joseph Wayne Freeman, Raleigh, NC (US); Steven Dale Goodman, Raleigh, NC (US); Randall Scott Springfield, Chapel Hill, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/745,152

(22) Filed: Dec. 22, 2003

(51) Int. Cl. H04L 9/32

(52) U.S. Cl. 713/188

(57) ABSTRACT

A method and system for preventing a denial of service attack on a computer system is disclosed. The method of the present invention includes setting a size of a hard disk within the computer system to a full capacity if the hard disk does not contain a host protected area, and locking the size such that the hard disk is protected from an attempt to reset the size of the hard disk resulting in a denial of service.

### FIELD OF THE INVENTION

The present invention relates to computer systems and more particularly to a method and system for preventing denial of service attacks on a computer system with a hard disk supporting a Host Protected Area.

### BACKGROUND OF THE INVENTION

Certain hard disks, including a hard disk on a personal computer, are often “partitioned” into multiple logical subdivisions. Each partition is essentially a separate portion of the disk, which is addressed and handled separately from the other partitions. The partition table of the disk (contained in the master boot record) tells the operating system of the extent of the partition as well as its type.

In some instances, it is desirable to place certain information and/or applications in an area that cannot be accessed by the operating system. Such an area is known as a Host Protected Area (HPA) or hidden partition. Such a partition is created by specific commands in the hard disk's microcode so that the actual control structure of the hard disk defines the HPA. For example, commands for creating an HPA in an ATA type hard disk are provided at http:/www.t13.org. The control structure defining the HPA, if it exists, is typically found in one sector, e.g., the last sector, of the hard disk. Notably, the partition table in the master boot record makes no reference to the HPA. Hence, the HPA is literally “invisible” to the operating system. The HPA is typically password protected to prevent an unauthorized user from issuing commands that would alter the control structure and from tampering with the content stored in the HPA.

The normal boot process of a computer system actuates the computer for reading from the partitions. At an appropriate point during the boot process, the system BIOS examines the hard disk prior to loading the operating system. In particular, BIOS reads the last sector of the hard disk to determine if it contains a valid control structure for an HPA. If an HPA is detected and if BIOS supports such a structure, BIOS enables the HPA. If an HPA is not detected, i.e., an HPA has not been created in the hard disk's control structures or if BIOS does not support such a structure, BIOS does nothing and continues with the normal boot process. This normal boot process includes loading the master boot record from the hard drive, investigating the partition table to find the different disk partitions, and loading the operating system from a bootable partition. After the operating system is fully loaded, the bootable partition, and all other partitions that the operating system is capable of interpreting, i.e., defined in the partition table, become fully accessible by the user.

A serious security problem presents itself if a hard disk that supports an HPA does not have an HPA. Because BIOS merely continues with the normal boot process if it does not detect an HPA, the hard disk is susceptible to a denial of service attack. For example, a rogue application introduced into the system, e.g., a virus, can issue the hard disk command sequence that creates the HPA, designate the entire hard disk as the HPA, and lock the HPA with a random password. Although rebooting the computer system can eliminate the password, the HPA setting survives across power cycles. Accordingly, the entire hard disk will continue to be designated an HPA and only the appropriate hard disk commands can alter the configuration.

Accordingly, a need exists for a system and method for preventing a denial of service attack on a computer system that has a hard drive that supports an HPA but does not have an HPA. The present invention addresses such a need.

### SUMMARY OF THE INVENTION

The present invention is directed to a method and system for preventing a denial of service attack on a computer system. The method of the present invention includes setting a size of a hard disk within the computer system to a full capacity if the hard disk does not contain a host protected area, and locking the size such that the hard disk is protected from an attempt to reset the size of the hard disk resulting in a denial of service.

Through the aspects of the present invention, a system BIOS locks the hard disk in a current or full capacity, depending on the existence of an HPA, before continuing with the normal boot process. By doing so, the hard disk configuration is protected from a rogue application attempting to create an HPA, where one does not already exist. Accordingly, the hard disk is protected from denial of service attacks.

### BRIEF DESCRIPTION OF THE DRAWINGS

FIG. 1 illustrates the hardware of the system in block diagram form in accordance with a preferred embodiment of the present invention.

FIG. 2 illustrates a flowchart for booting the system in accordance with the present invention.

### DETAILED DESCRIPTION

The present invention relates to computer systems and more particularly to a method and system for preventing denial of service attacks on a computer system with a hard disk supporting a Host Protected Area. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

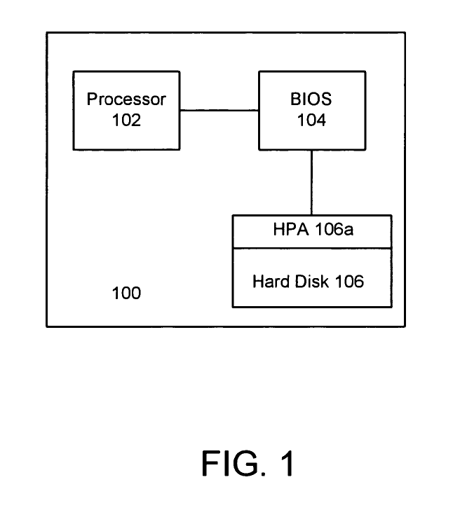

FIG. 1 illustrates the hardware of the computer system 100 in block diagram form. The overall system 100 is driven by a processor 102. Initial start up or boot of the computer is based on the contents of the BIOS 104. In a typical boot sequence where BIOS supports an HPA, the following steps are performed:
1. BIOS 104 picks a boot device from a boot list, where the boot device is the hard disk 106;
2. BIOS 104 examines the configuration for the hard disk 106, i.e., it reads the last sector of the hard disk, to determine whether it contains a valid control structure for defining an HPA 106a;
3. If an HPA 106a is not found, BIOS 104 goes directly to step 4, else BIOS 104 enables the HPA 106a, and sets the size of the hard disk 106 to a current capacity, which is the difference between the hard disk's maximum capacity and the size of the HPA 106a;
4. BIOS 104 loads and transfers control to the master boot record (MBR);
5. The MBR locates an active partition and loads an operating system in the active partition; and
6. The MBR transfers control to the operating system.

As stated above, this process fails to protect the hard disk 106 from a rogue application when the hard disk 106 does not contain an HPA 106a or if BIOS does not support such a structure. In one scenario, the rogue application can issue the appropriate commands to reset the configuration in the hard disk 106 to designate the entire hard disk 106 as an HPA 106a. In another scenario, the rogue application can bypass the commands and write a valid HPA control structure directly to the last sector of the hard disk 106 to reset the configuration. Once this is done, the hard disk 106 and all its data are essentially invisible to the computer system, thus resulting in a denial of service.

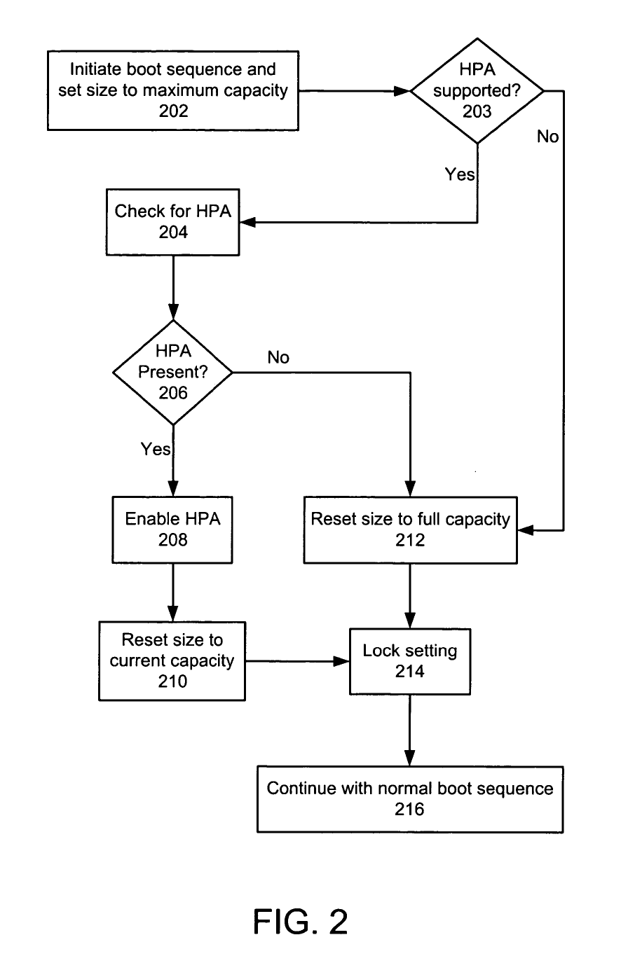

According to a preferred embodiment of the present invention, BIOS 104 performs an enhanced boot sequence to protect the hard disk 106 from such denial of service attacks. FIG. 2 is a flowchart illustrating the enhanced boot sequence according to a preferred embodiment of the present invention. In step 202, the boot sequence is initiated, e.g., BIOS 104 performs the initial calls which initiate operations of the computer system and sets the size of the hard disk to its maximum capacity. If BIOS supports an HPA structure (step 203), in step 204, BIOS 104 examines a configuration of the hard disk 106 to determine whether an HPA 106a exists. The configuration for the hard disk 106, which is found in the last sector, defines, among other things, the physical starting and ending sectors of the HPA 106a, if such an area is created. If the HPA 106a is found (step 206), BIOS 104 enables the HPA 106a in step 208, and resets the size of the hard disk 106 to a current capacity, which is the difference between the maximum capacity and the size of the HPA 106a, via step 210.

If the HPA 106a is not found in the hard disk 106 or if BIOS does not support the HPA, BIOS 104 resets the size of the hard disk 106 to a full capacity, which is defined as the maximum capacity less one sector, namely the last sector in step 212. After the hard disk size is reset to the current capacity (step 210) or, alternatively, to the full capacity (step 212), BIOS 104 locks the size for the hard disk 106 with, for example, a random password, in step 214.

Accordingly, at this point in the boot sequence, the size of the hard drive 106 is locked at a current capacity (e.g., if an HPA 106a is present) or at a full capacity (e.g., if an HPA 106a is not present or if BIOS does not support the HPA 106a) by a random password. From this point forward, BIOS 104 performs the normal boot sequence (step 216) which includes loading the master boot record, loading the operating system, and transferring control to the operating system.

Through aspects of the present invention, a hard disk 106 that supports an HPA, but does not have such a structure is protected from commands to create an HPA issued by an unauthorized user or rogue application. Moreover, by setting the size of the hard disk 106 to the full capacity, rather than the maximum capacity, if the hard disk 106 does not have an HPA or if BIOS does not support such a structure, the last sector of the hard disk 106 is essentially hidden from the operating system. Thus, a rogue application cannot create an HPA by writing directly to the last sector of the hard disk. By setting and locking the size of the hard disk 106 during the initial phases of the boot process, the computer system is protected from denial of service attacks of this kind.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for preventing a denial of service attack on a computer system comprising:
a) setting a size of a hard disk within the computer system to a full capacity if the hard disk does not contain a host protected area; and
b) locking the size, thereby protecting the hard disk from an attempt to reset the size of the hard disk resulting in a denial of service.

2. The method of claim 1 wherein the full capacity is the difference between a maximum capacity of the hard disk and a size of one sector.

3. The method of claim 1, further comprising:
c) examining a configuration of the hard disk to determine whether the hard disk includes the host protected area;
d) enabling the host protected area if the hard disk includes such an area;
e) setting a size of the hard disk to a current capacity, wherein the current capacity is the difference between a maximum capacity and a size of the host protected area; and
f) locking the size.

4. The method of claim 1, wherein steps (a) through (b) are performed during a boot sequence by a system BIOS.

5. The method of claim 4 further comprising:
c) setting the size of the hard disk within the computer system to the full capacity prior to locking step (b) if the system BIOS does not support a host protected area.

6. The method of claim 4, wherein steps (a) through (b) are performed prior to loading a master boot record and prior to loading an operating system.

7. The method of claim 1, wherein the locking step (b) includes:
(b1) generating a password to protect the size.

8. A system for preventing a denial of service attack on a computer system comprising:
a processor in the computer system; and
a system BIOS including:
means for setting a size of a hard disk within the computer system to a full capacity if the hard disk does not contain a host protected area; and
means for locking the size,
wherein the hard disk is protected from an attempt to reset the size of the hard disk resulting in a denial of service.

9. The system of claim 8 wherein the full capacity is the difference between a maximum capacity of the hard disk and a size of one sector.

10. The system of claim 8 wherein the system BIOS further comprises:
means for examining a configuration of the hard disk to determine whether the hard disk includes the host protected area;
means for enabling the host protected area if the hard disk includes such an area; and
means for setting a size of the hard disk to a current capacity, wherein the current capacity is the difference between a maximum capacity and a size of the host protected area.

11. The system of claim 8, wherein the system BIOS further includes means for loading a master boot record and means for loading an operating system.

12. The method of claim 8, wherein the means for locking includes:
means for generating a password to protect the size.

13. A computer readable medium containing program instructions for preventing a denial of service attack on a computer system comprising:
a) setting a size of a hard disk within the computer system to a full capacity if the hard disk does not contain a host protected area; and
b) locking the size, thereby protecting the hard disk from an attempt to reset the size of the hard disk resulting in a denial of service.

14. The computer readable medium of claim 13 wherein the full capacity is the difference between a maximum capacity of the hard disk and a size of one sector.

15. The computer readable medium of claim 13 further comprising:
c) examining a configuration of the hard disk to determine whether the hard disk includes the host protected area;
d) enabling the host protected area if the hard disk includes such an area;
e) setting a size of the hard disk to a current capacity, wherein the current capacity is the difference between a maximum capacity and a size of the host protected area; and
f) locking the size.

16. The computer readable medium of claim 13, wherein instructions (a) through (b) are performed during a boot sequence by a system BIOS.

17. The computer readable medium of claim 16, wherein instructions (a) through (b) are performed prior to loading a master boot record and prior to loading an operating system.

18. The computer readable medium of claim 16 further comprising:
c) setting the size of the hard disk to the full capacity prior to locking step (b) if the system BIOS does not support a host protected area.

19. The computer readable medium of claim 13, wherein the locking instruction (b) includes:
(b1) generating a password to protect the size.
